(19) United States
(12) Patent Application Publication
(10) Pub. No.: US 2015/0042765 A1
(43) Pub. Date: Feb. 12, 2015

(54) 3D Camera and Method of Detecting Three-Dimensional Image Data

(71) Applicant: SICK AG, Waldkirch (DE)

(72) Inventor: Thorsten PFISTER, Waldkirch (DE)

(21) Appl. No.: 14/325,562

(22) Filed: Jul. 8, 2014

(30) Foreign Application Priority Data
Aug. 6, 2013 (EP) 13179412.5

(51) Int. Cl. H04N 13/02; G02B 5/10; B60R 1/00; G02B 17/00

(52) U.S. Cl. CPC H04N 13/0239; H04N 13/0282; G02B 17/002; G02B 5/10; B60R 1/002
USPC 348/48; 348/47

(57) ABSTRACT

A 3D camera (10) having at least one image sensor (16, 16a-b) for detecting three-dimensional image data from a monitored zone (12, 34, 36) and having a mirror optics (38) disposed in front of the image sensor (16, 16a) for expanding the field of view (44) is provided. In this respect, the mirror optics (38) has a front mirror surface (40) and a rear mirror surface (42) and is arranged in the field of view (44) of the image sensor (16, 16a-b) such that the front mirror surface (40) generates a first partial field of view (34) over a first angular region and the rear mirror surface (42) generates a second partial field of view (36) over a second angular region, with the first angular region and the second angular region not overlapping and being separated from one another by non-monitored angular regions.

The invention relates to a 3D camera and to a method of detecting three-dimensional image data using a mirror optics for expanding the field of view in accordance with the preambles of claim 1 and claim 15 respectively.

Unlike a conventional camera, a 3D camera also takes depth information and thus generates three-dimensional image data having spacing values or distance values for the individual pixels of the 3D image which is also called a distance image or a depth map. The additional distance dimension can be utilized in a number of applications to obtain more information on objects in the scene detected by the camera and thus to solve different objects in the area of industrial sensor systems.

In automation technology, objects can be detected and classified with respect to three-dimensional image data in order to make further automatic processing steps dependent on which objects were recognized, preferably including their positions and orientations. The control of robots or different types of actuators at a conveyor belt can thus be assisted, for example.

In mobile applications, whether vehicles with a driver such as passenger vehicles, trucks, work machines or fork-lift trucks or driverless vehicles such as AGVs (automated guided vehicles) or floor-level conveyors, the environment and in particular a planned travel path should be detected as completely as possible and in three dimensions. Autonomous navigation should thus be made possible or a driver should be assisted in order inter alia to recognize obstacles, to avoid collisions or to facilitate the loading and unloading of transport goods, including cardboard boxes, pallets, containers or trailers.

Different processes are known for determining the depth information such as time-of-flight measurements or stereoscopy. In a time-of-flight measurement, a light signal is transmitted and the time up to the reception of the remitted light signal is measured. A distinction is made between pulse processes and phase processes here. Stereoscopic processes are based on stereoscopic vision with two eyes and search mutually associated picture elements in two images taken from different perspectives; the distance is estimated by triangulation from the disparity of said picture elements with knowledge of the optical parameters of the stereoscopic camera. Stereo systems can work passively, that is only with the environmental light, or can have their own illumination which preferably generates a lighting pattern in order also to allow the distance estimation in structureless scenes. In a further 3D-imaging process which is known from U.S. Pat. No. 7,433,024, for example, a lighting pattern is only taken by one camera and the distance is measured by pattern evaluation.

The field of view (FOV) of such 3D cameras is limited, even with fish-eye lenses, to less than 180° and in particular typically even to less than 90°. It is conceivable to expand the field of view by using a plurality of cameras, but this incurs substantial hardware and adjustment costs.

Various mirror optics for achieving omnidirectional 3D-imaging are known in the prior art, for example from U.S. Pat. No. 6,157,018 or WO 0 176 233 A1. Such cameras are called catadioptric cameras due to the combination of an imaging optics and of a mirror optics connected downstream. Nayar and Baker in “Catadioptric image formation”, Proceedings of the 1997 DARPA Image Understanding Workshop, New Orleans, May 1997, pages 1431-1437 have shown that a so-called single-viewpoint condition has to be met for rectification. This is the case for typical mirror shapes such as elliptical, parabolic, hyperbolic or conical mirrors.

Alternatively, a plurality of successively arranged mirrors can be used such as in EP 1 141 760 B1 or U.S. Pat. No. 6,611,282 B1, for example. EP 0 989 436 A2 discloses a stereoscopic panorama taking system having a mirror element which is shaped like a pyramid having a quadratic base surface and standing on its head. The field of view of a camera is divided with the aid of a mirror element in U.S. Pat. No. 7,710,451 B1 so that two virtual cameras are created which are then utilized as a stereo camera. WO 2012/038601 associates one respective mirror optics with two image sensors in order thus to be able to detect a 360° region stereoscopically. In a similar construction, but with a different mirror shape, a structured light source and a mono camera are used in a triangulation process in U.S. Pat. No. 6,304,285 B1. This results in large construction heights. In addition, the mirror optics, like the total construction, are complex and can therefore not be manufactured inexpensively.

It is therefore an object of the invention to expand the visual range of a 3D camera using simple means.

This object is satisfied by a 3D camera and by a method of detecting three-dimensional image data in accordance with claim 1 and claim 15 respectively. In this respect, the invention starts from the basic idea of monitoring a two-part field of view, that is to make a bidirectional camera from the 3D camera with the aid of the mirror optics. The mirror optics accordingly preferably has exactly two mirror surfaces which each generate an associated partial field of view. Two separate partial fields of view are thus monitored which each extend over an angular range. The two partial fields of view are separated by angular regions, preferably likewise two angular regions, which are not detected by the two mirror surfaces so that no 3D image data are generated at these angles. Such a mirror optics having two mirror surfaces makes it possible substantially to simplify the construction design with respect to omnidirectional 3D cameras. At the same time, a bidirectional image detection is particularly useful especially for vehicles. For although some vehicles are able to move in any desired directions, the movement is, however, typically limited to a forward movement and a reverse movement and a sideward movement or rotation while standing are not possible. It is then, however, also sufficient to detect the spatial regions in front of and behind the vehicle.

The invention has the advantage that a 3D camera can be expanded in a very simple manner. The mirror optics used in accordance with the invention is even suitable to retrofit a conventional 3D camera having a small field of view into a bidirectional camera. This facilitates the use of and the conversion to the 3D camera in accordance with the invention. The three-dimensional environmental detection becomes particularly compact, efficient and inexpensive. In addition, the bidirectional 3D camera has a small construction size and above all construction height so that it at most slightly projects beyond the vehicle when used at a vehicle.

The mirror optics is preferably shaped as a ridge roof whose ridge is aligned perpendicular to the optical axis of the image sensor and faces the image sensor so that the roof surfaces form the front mirror surface and the rear mirror surface. The term ridge roof has been deliberately chosen as illustrative. This shape could alternatively be called a wedge; a triangular prism would be mathematically correct. These terms are, however, to be understood in a generalized sense. No regularity is first required, nor do the outer surfaces have to be planar, but can also have curves, which would at least be unusual with a ridge roof. It is furthermore only a question of the two surfaces which correspond to the actual roof surfaces in a ridge roof for they are the two mirror surfaces. The remaining geometry plays no role optically and can be adapted to construction demands. This also includes the fact that the ridge roof of the mirror optics is solely reduced to the mirror surfaces.

In a preferred embodiment, the ridge roof is regular and symmetrical. In this respect, the triangular base surfaces are equal-sided and the ridge is perpendicular to these base surfaces and to the axis of symmetry of the triangular base surfaces and extends through the tip of the triangular base surface in which the two sides intersect. Two similar mirror surfaces, in particular also planar mirror surfaces, of the same size and inclination then result and accordingly two similar first and second partial fields of view. Radial image distortions are thereby avoided, the vertical resolution only changes in a linear fashion and a simple image transformation is made possible. In addition, such a mirror optics can be produced simply and exactly.

The ridge is preferably arranged offset from the optical axis of the image sensor. A large portion of the surface of the image sensor is thereby associated with one of the partial fields of view and a partial field of view is thus accordingly enlarged at the cost of the other partial field of view.

The front mirror surface and the rear mirror surface preferably have different sizes. This relates to the relevant surfaces, that is to those portions which are actually located in the field of view of the image sensor. For example, in the case of a mirror optics shaped as a ridge roof, the one roof surface is drawn down lower than the other. A partial field of view is in this manner again enlarged at the cost of the other partial field of view.

The front mirror surface preferably has a different inclination with respect to the optical axis of the image sensor than the rear mirror surface. The monitored partial fields of view thus lie at different vertical angles. If the mirror surfaces are not planar, then inclination does not mean a local inclination, but rather a global total inclination, for example a secant which connects the outermost points of the respective roof surface.

At least one of the mirror surfaces has a convex or concave contour at least sectionally. This contour is pronounced over a total mirror surface in an embodiment. Alternatively, curves and thus the resulting spatial fields of view are locally matched.

The contour is preferably formed in the direction of the optical axis of the image sensor. The direction of this optical axis is also called a vertical direction. A concave curvature then means more of a lateral point of view, that is an extent of the point of view larger in the vertical direction, with in turn fewer pixels per angular region or less resolution capability, and concave curvature means the converse.

The contour is preferably peripheral about the optical axis of the image sensor to vary the first angular region and/or the second angular region. Such a contour changes the angular region of the associated partial field of view which is increased with a loss of resolution with a concave curvature and conversely with a convex curvature. If the curvature is only local, the effects also only occur in the respective partial angular region. Due to the division of the mirror optics into a front mirror surface and a rear mirror surface, such contours remain much flatter than in the case of a conventional omnidirectional mirror optics.

The 3D camera is preferably formed as a stereo camera and for this purpose has at least two camera modules, each having an image sensor in a mutually offset perspective and has a stereoscopic unit in which mutually associated part regions are recognized by means of a stereo algorithm in images taken by the two camera modules and their distance is calculated with respect to the disparity, with each camera module being configured as a bidirectional camera with the aid of a mirror optics which is disposed in front of the image sensor and which has a front mirror surface and a rear mirror surface. The mirror optics can have any shape described here, but are preferably at least substantially similar for all camera modules among one another since the finding of correspondences in the stereo algorithm is made more difficult or is prevented with differences which are too large.

The mirror optics preferably have a convex contour which runs around the optical axis of the associated image sensor and which is curved just so much that the non-monitored angular regions of a respective camera module correspond to a zone shaded by the other camera modules. This ideally utilizes the advantages of a divided mirror optics. An omnidirectional mirror optics would be more complex and would have greater distortion, although the additional visual range would anyway be lost due to shading.

The 3D camera preferably has a lighting unit for generating a structured lighting pattern in the monitored zone, with a mirror optics having a front mirror surface and a rear mirror surface being disposed in front of a lighting unit. This mirror optics can also adopt any shape described here in principle. Unlike the camera modules of a stereo camera, no value also has to be placed on the fact that the mirror optics is similar to other mirror optics, although this can also be advantageous here due to the simplified manufacture and processing.

The 3D camera is preferably configured as a time-of-flight camera and for this purpose has a lighting unit and a time-of-flight unit to determine the time-of-flight of a light signal which is transmitted by the lighting unit, which is remitted at objects in the monitored zone and which is detected in the image sensor. A respective one mirror optics is in this respect preferably associated with both the lighting unit and the image sensor or the detection unit. The lighting unit can furthermore comprise a plurality of light sources with which a mirror optics is respectively associated individually, in groups or in total. The mirror optics can again adopt any shape described here and are preferably the same among one another.

The mirror optics are preferably configured as a common component. Whenever a plurality of mirror optics are required, for instance to split the fields of view and the illuminated fields of the two modules of a stereo camera or of the lighting and detection modules of a stereo camera, a mono camera or a time-of-flight camera, at least one separate component can be saved in this manner. The system thereby becomes more robust and additionally easier to produce and to adjust. A common component can be produced particularly easily if the mirror optics are the same among one another and are configured as flat in the direction in which they are arranged offset with respect to one another.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

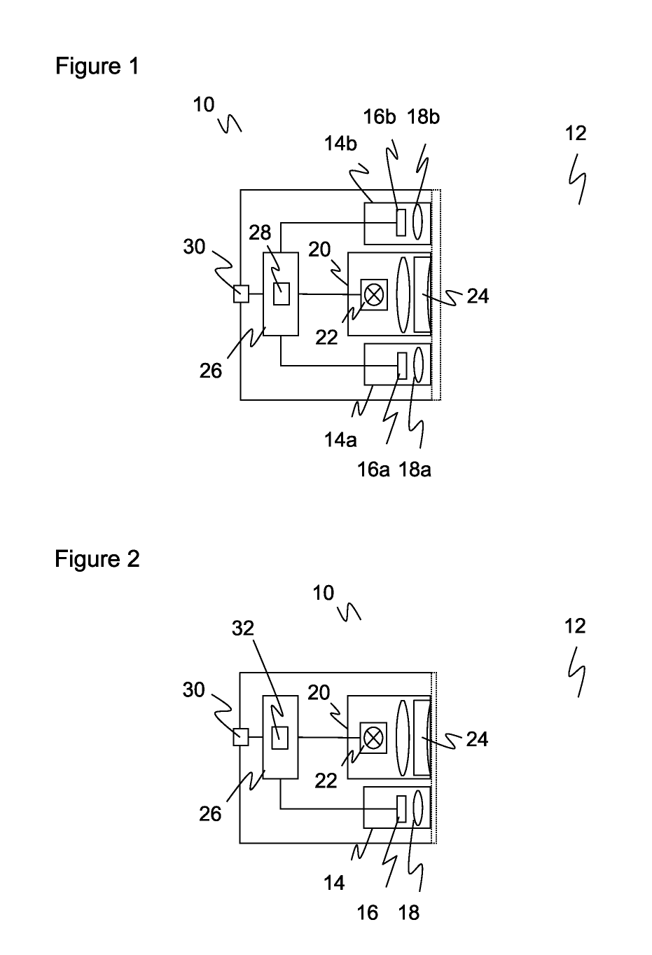

FIG. 1 a block diagram of a stereo 3D camera;

FIG. 2 a block diagram of a time-of-flight camera;

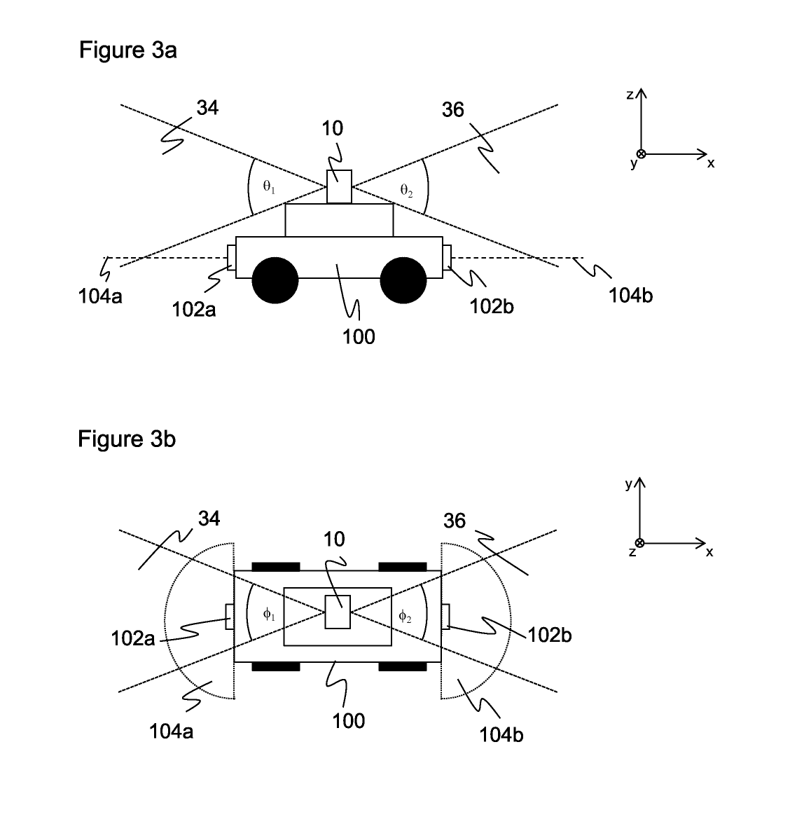

FIG. 3a a side view of a vehicle having a bidirectional 3D camera;

FIG. 3b a plan view of the vehicle in accordance with FIG. 3a;

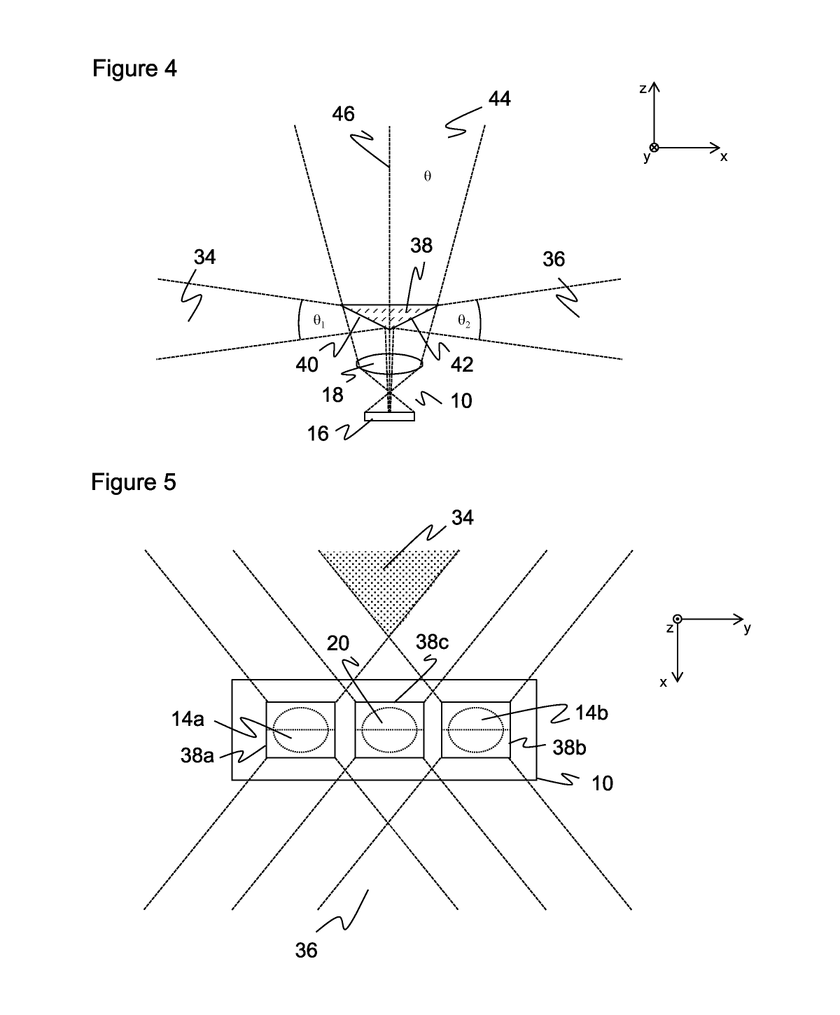

FIG. 4 a side view of a bidirectional 3D camera having a mirror optics;

FIG. 5 a plan view of a stereo camera having lighting and mirror optics respectively associated with the modules;

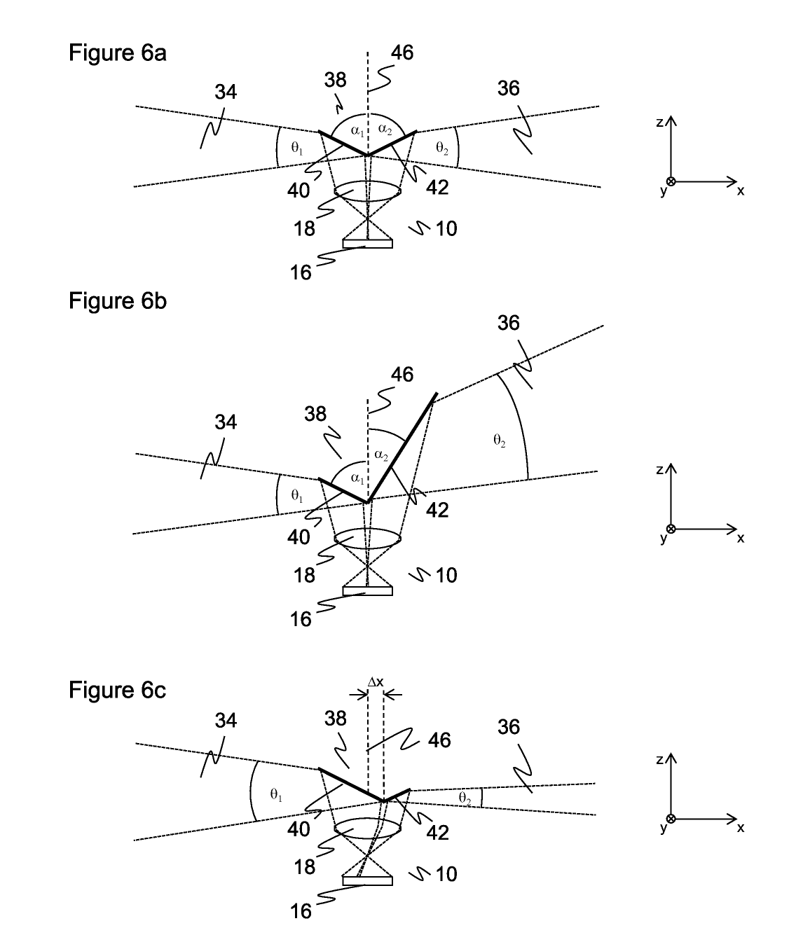

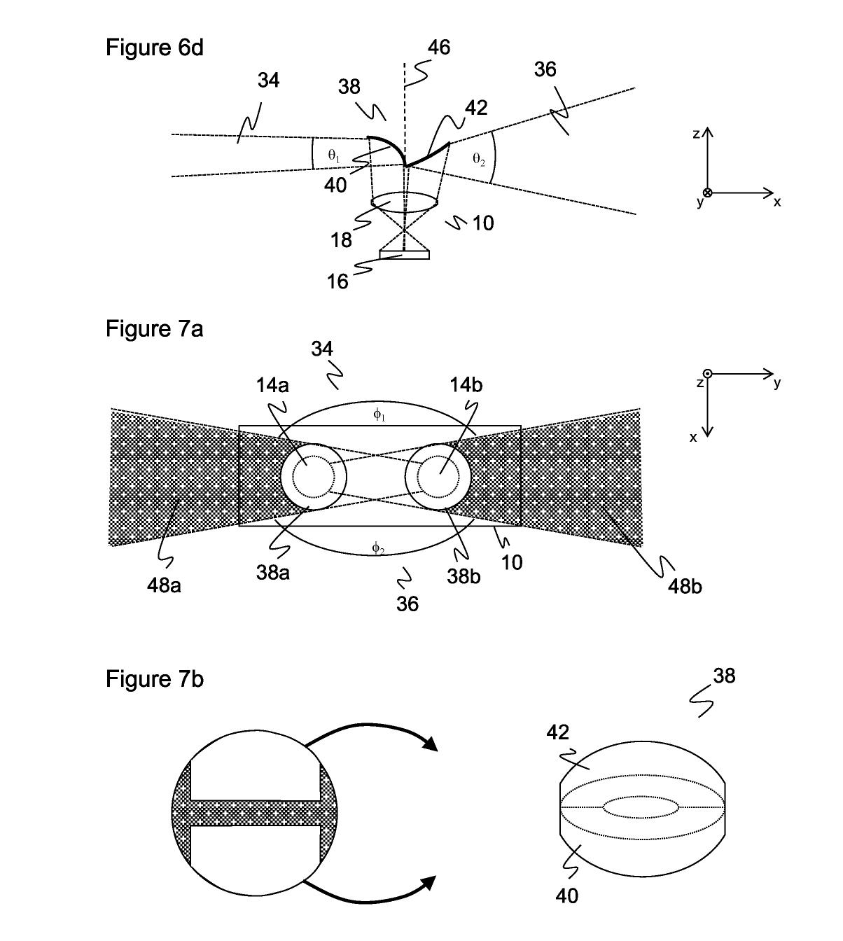

FIG. 6a a side view of a bidirectional 3D camera having a mirror optics of regular design;

FIG. 6b a side view similar to FIG. 6a having differently inclined mirror surfaces;

FIG. 6c a side view similar to FIG. 6a having a laterally offset mirror optics:

FIG. 6d a side view similar to FIG. 6a having curved mirror surfaces;

FIG. 7a a plan view of a stereo 3D camera having a two-surface mirror optics and shaded regions;

FIG. 7b an illustration of a mirror optics with which the blind regions between the partial fields of view of the mirror surfaces of a bidirectional 3D camera just correspond to the shaded regions shown in FIG. 7a due to a peripheral convex contour of the mirror surfaces;

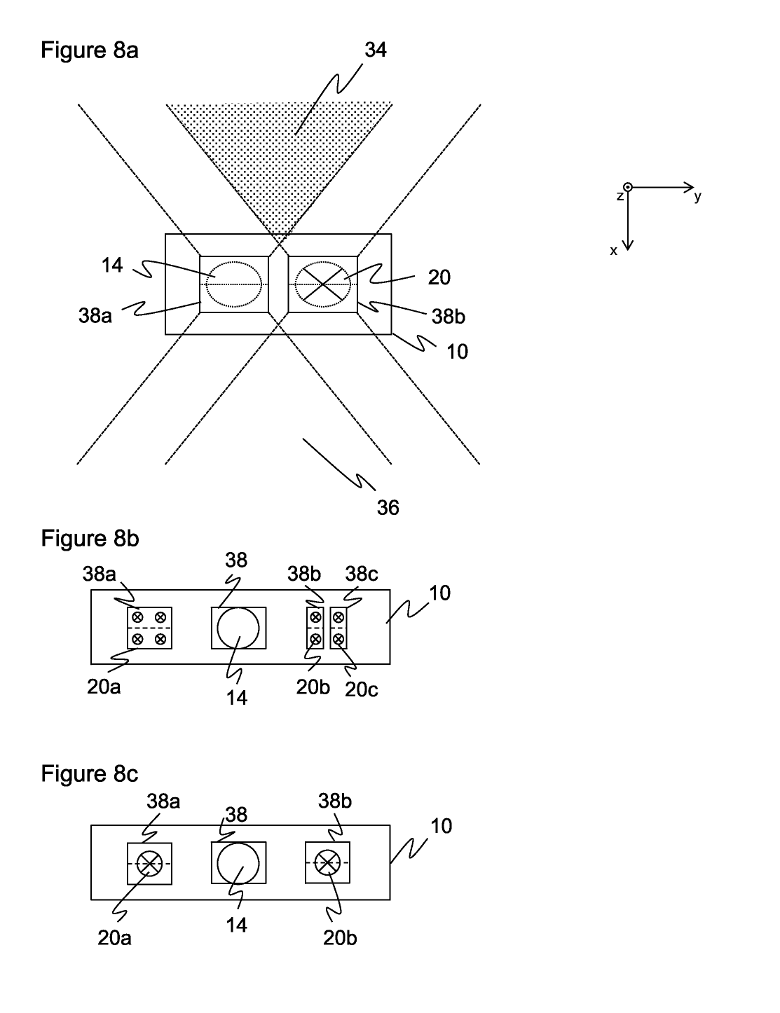

FIG. 8a a plan view of a time-of-flight camera having lighting and having mirror optics respectively associated with the modules;

FIG. 8b a schematic plan view of a time-of-flight camera similar to FIG. 8a having a first variant of light sources of the lighting and of the mirror optics associated therewith; and

FIG. 8c a schematic plan view of a time-of-flight camera similar to FIG. 8a having a second variant of light sources of the lighting and of mirror optics associated therewith.

FIG. 1 first shows in a block diagram without a mirror optics in accordance with the invention the general design of a 3D camera 10 for taking depth maps of a monitored or spatial zone 12. These depth maps are further evaluated, for example, for one of the applications named in the introduction.

Two camera modules 14a-b are mounted at a known fixed spacing from one another in the 3D camera 10 and each take images of the spatial zone 12. An image sensor 16a-b, usually a matrix-type imaging chip, is provided in each camera and takes a rectangular pixel image, for example a CCD or a CMOS sensor. A respective objective having an imaging optics is associated with the image sensors 16a-b; it is shown as a lens 18a-b and can in practice be realized as any known imaging optics.

A lighting unit 20 having a light source 22 is shown in the middle between the two camera modules 14a-b. This spatial arrangement is only to be understood as an example and the importance of the mutual positioning of camera modules 14a-b and lighting unit 20 will be looked at in further detail below. The lighting unit 20 generates a structured lighting pattern in the spatial zone 12 with the aid of a pattern generation element 24. The lighting pattern should preferably be unambiguous or irregular at least locally in the sense that structures of the lighting pattern do not result in spurious correlations, for example clearly mark an illumination zone.

A combined evaluation and control unit 26 is associated with the two image sensors 16a-b and the lighting unit 20. The structured lighting pattern is produced by means of the evaluation and control unit 26 which receives image data of the image sensors 16a-b. A stereoscopic unit 28 of the evaluation and control unit 26 having a stereo algorithm known per se calculates three-dimensional image data (distance image, depth map) of the spatial zone 12 from these image data.

The 3D camera 10 can output depth maps or other measured results via an output 30; for example, raw image data of a camera module 14a-b, but also evaluation results such as object data or the identification of specific objects. Especially in a safety engineering application, the recognition of an unauthorized intrusion into protected fields which were defined in the spatial zone 12 can result in the output of a safety-oriented shut-down signal. For this reason, the output 30 is then preferably designed as a safety output (OSSD, output signal switching device) and the 3D camera is structured in total as fail-safe in the sense of relevant safety standards.

FIG. 2 shows in a further block diagram an alternative embodiment of the 3D camera 10 as a time-of-flight camera. In this respect, here and in the following, the same reference numerals designate features which are the same or which correspond to one another. Over the relatively rough plane of the representation, the time-of-flight camera mainly differs from a stereo camera by the lack of a second camera module. Such a design is also that of a 3D camera which estimates distances in a projection process from distance-dependent changes in the lighting pattern. A further difference comprises the fact that the evaluation is a different one. For this purpose, instead of the stereoscopic unit 28, a time-of-flight unit 32 is provided in the evaluation and control unit 26 which measures the time-of-flight between the transmission and reception of a light signal. The time-of-flight unit 32 can also be directly integrated into the image sensor 16, for example in a PMD chip (photon multiplicity detection). An adapted unit for evaluating the lighting pattern is accordingly provided in a 3D camera for a projection process.

FIGS. 3a and 3b show in a side view and in a plan view respectively a vehicle 100 which monitors its environment using a bidirectional 3D camera 10 in accordance with the invention. For this purpose, a special mirror optics which is explained further below in different embodiments is disposed downstream of a conventional 3D camera such as was described with reference to FIGS. 1 and 2.

The field of view of the 3D camera is divided by this mirror optics into a front partial field of view 34 and a rear partial field of view 36. The 360° around the vehicle 100 in accordance with the plane of the drawing in the plan view in accordance with FIG. 3b are divided into two monitored angular regions φ₁, φ₂ of the partial fields of view 34, 36 and into non-monitored angular regions disposed therebetween. In this manner, the spatial zones in front of and behind the vehicle 100 can be monitored using the same 3D camera 10. In FIGS. 3a-b, the vehicle 100 is additionally equipped with two laser scanners 102a-b whose protected fields 104a-b serve for the avoidance of accidents with persons. The laser scanners 102a-b are used for safety engineering reasons as long as the 3D monitoring has still not reached the same reliability for the timely recognition of persons.

FIG. 4 shows a first embodiment of the mirror optics 38 in a side view. It has the shape of a triangular prism of which only the base surface configured as an isosceles triangle can be recognized in the side view. Since it is a perpendicular triangular prism, the base surface can be found in identical shape and position on each cut level. For reasons of illustration, the geometrical shape of the triangular prism is called a ridge roof in the following. It must be noted in this respect that the regular symmetrical shape of the ridge roof is initially only present for this embodiment. In further embodiments, the position and shape is varied by changes in the angles and side surfaces and even by curved side surfaces. In each case, the roof surfaces of the ridge-roof are optically relevant which form a front mirror surface 40 and a rear mirror surface 42. It is then constructionally particularly simple to configure the mirror optics as a solid ridge roof. However, it is possible to deviate from this construction practically as desired as long as the roof surfaces are maintained and such variants are also still understood as the shape of a roof ridge.

The 3D camera 10 itself is in this respect only shown rudimentarily by its image sensor 16 and its reception optics 18. Without the mirror optics 38, a field of view 44 results having an opening angle θ and extending symmetrically about the optical axis 46 of the image sensor 16. In this field of view 44, the mirror optics 38 is arranged with the ridge of the ridge roof facing down such that the optical axis 46 extends perpendicular through the ridge and in particular through the fridge center, with the optical axis 46 at the same time forming the axis of symmetry of the triangular base surface of the ridge roof. In this manner, the field of view 44 is divided into the two partial fields of view 34, 36 which are substantially oriented perpendicular to the optical axis 46. The exact orientation of the partial fields of view 34, 36 with respect to the optical axis 46 depends on the geometry of the mirror optics. In the example of the use at a vehicle, the 3D camera 10 thus looks upward and its field of view is divided by the mirror optics 36 into a partial field of view 34 directed to the front and a partial field of view 36 directed to the rear.

FIG. 5 shows a plan view of a 3D camera 10 configured as a stereo camera. A respective mirror optics 38a-c is disposed upstream of each of the camera modules 14a-b and of the lighting unit 20. In this respect, it is preferably a case of mutually similar mirror optics 38a-c, particularly with the mirror optics 38-ab for the camera modules 14a-b in order not to deliver any unnecessary distortion to the stereo algorithm. The individual fields of view and lighting fields of the camera modules 14a-b and of the lighting unit 20 are split by the mirror optics 38a-c into respective front and rear partial fields. The overlap region in which both camera modules 14a-b detect image data and the scene is illuminated results as an effective front partial field of view 34 and rear partial field of view 36. This region only appears particularly small in FIG. 5 because only the near zone is shown here.

In an alternative embodiment, not shown, the mirror optics 38a-c are configured as a common component. This is in particular possible when no curvature is provided in a direction in which the mirror optics 38a-c are arranged offset from one another, as in a number of the embodiments described in the following.

FIG. 6 shows in side views different embodiments of the mirror optics 38 and partial fields of view 34, 36 resulting with them. In this respect, FIG. 6a largely corresponds to FIG. 4 and serves as a starting point for the explanation of some of the numerous conceivable variation possibilities. These variations can also be combined with one another to arrive at even further embodiments.

The embodiments explained with reference to FIG. 6 have in common that the front mirror surface 40 and the rear mirror surface 42 do not have any shape differences in the plane of the drawing perpendicular to the direction marked by y. If the direction of the optical axis 46 is understood as the vertical axis, the mirror surfaces 40, 42 therefore remain flat in all vertical sections. This property has the advantage that no adaptations of a stereo algorithm or of a triangulation evaluation of the project lighting pattern are necessary. This is due to the fact that the disparity estimate or the correlation evaluation of the lighting pattern anyway only takes place in the y direction, that is at the same level at which no distortion is introduced.

With the regular, symmetrical mirror optics 38 in accordance with FIG. 6a, the roof surfaces of the ridge roof, as the front mirror surface 40 and the rear mirror surface 42 are frequently called here, remain planar and of the same size among one another. The tilt angles α₁, α₂ are also the same with respect to the optical axis 46. The light is thereby deflected in and from the front and rear directions respectively in a uniform and similar manner. The part fields of view 34, 36 are of the same size among one another and have the same vertical orientation which is determined by the tilt angles α₁=α₂.

FIG. 6b shows a variant in which the two tilt angles α₁, α₂ are different. One of the mirror surfaces 42 is thereby at the same time larger than the other mirror surface 40 so that the original field of view 44 is completely utilized by the mirror optics 38. This can alternatively also be achieved with the same size of the mirror surfaces 40, 42 by an offset of the ridge with respect to the optical axis 46.

The different tilt angles α₁, α₂ result in a different vertical orientation of the partial fields of view 34, 36. This can be advantageous, for example, to monitor the zone close to the ground in front of the vehicle 100 and a spatial zone located above the ground behind the vehicle 100, for instance above a trailer.

FIG. 6c shows an embodiment with an off-center position of the mirror optics 38. The ridge in this respect is given an offset Δx with respect to the optical axis 46. At the same time, the field of view 44 is still completely covered in that the one mirror surface 40 is enlarged in accordance with the offset and the other mirror surface 42 is reduced in size. The image points of the image sensor 16 or of its surface are thereby unevenly distributed and a larger partial field of view 34 arises with a larger opening angle θ₁ and a smaller partial field of view 36 with a smaller opening angle θ₂. With a vehicle 100, this is useful, for example, if a larger field of view or more measurement points are required toward the front than toward the rear.

FIG. 6d shows an embodiment in which the mirror surfaces 40, 42 are no longer planar, but rather have a curvature or contour. This curvature, however, remains limited to the vertical direction given by the optical axis 46. The mirror surfaces are still in a lateral direction, that is flat at the same level in accordance with the perpendicular to the plane of the drawing called the y direction. The measured point density and thus the vertical resolution in the associated partial field of view 34 is increased by a concave curvature such as that of the front mirror surface 40 at the cost of a vertical opening angle θ₁ reduced in size. Conversely, the measured point density can be reduced by a convex curvature such as that of the rear mirror surface 42 to gain a larger vertical opening angle θ₂ at the cost of a degraded resolution.

As a further variation, the curvature or contour can also only be provided sectionally instead of uniformly as in FIG. 6d. For example, for this purpose, a mirror surface 40, 42 is provided with an S-shaped contour which is convex in the upper part and concave in the lower part. The measured point density is thereby varied within a partial field of view 34, 36. In a similar manner, any desired sections, in particular parabolic, hyperbolic, spherical, conical or also elliptical sections, can be combined to achieve a desired distribution of the available measured points over the vertical positions adapted to the application.

The embodiments described with reference to FIG. 6 can be combined with one another. In this respect, numerous variants of mirror surfaces 40. 42 arise having different tilt angles, sizes, a different offset with respect to the optical axis and contours in the vertical direction in which the corresponding individually described effects complement one another.

Whereas in the embodiments described with reference to FIG. 6, the mirror surfaces 40, 42 are planar and thus have no contour in the direction marked by y, that is at the same vertical positions with respect to the optical axis 46, a further embodiment will now be described with reference to FIG. 7 which has a peripheral contour at the same level. However, with 3D cameras 10, which are based on mono triangulation or stereo triangulation, that is on the evaluation of a projected lighting pattern or on a stereo algorithm, a rectification of the images or an adaptation of the evaluation is thus required.

As with conventional omnidirectional mirror optics, the peripheral contour should satisfy the single-viewpoint condition named in the introduction, that is it should, for example, be elliptical, hyperbolic or conic to allow a loss-free rectification. Unlike the conventional mirror optics, however, no 360° panorama view is produced, but rather two separate partial fields of view 34, 36 are still generated which are separated from one another by non-monitored angular regions.

If a stereo 3D camera 10 is again looked at in a plan view in accordance with FIG. 7a, it can be recognized that the two camera modules 14a-b shade one another in part such as illustrated by dark zones 48a-b. If now the mirror optics 38a-b were to allow an omnidirectional perspective, a part of the available picture elements of the images sensors 16 would be wasted because they only pick up the shaded dark zones 48a-b which cannot be used for a 3D evaluation.

In the embodiment in accordance with the invention as illustrated in FIG. 7b, a mirror optics 38 is therefore selected in which the two mirror surfaces 40, 42 just do not detect an angular region which corresponds to the dark zones 48a-b due to their peripheral contour. All the available picture elements are thus concentrated onto the partial fields of view 34, 36. Such a mirror optics 38 also manages with a much smaller curvature and therefore introduces less distortion.

FIG. 8a shows in a plan view a further embodiment of the 3D camera 10 as a time-of-flight camera in accordance with the basic structure of FIG. 2. A mirror optics 38a-b is respectively associated with the camera module 14 and the lighting 20 to divide the field of view or the lighting field. The monitored partial fields of view 34, 36 thereby result in the overlap zones. A time-of-flight camera is less sensitive with respect to distortion so that contours in the y direction are also possible without complex image rectification or adaptation of the evaluation.

As illustrated in FIGS. 8b and 8c which show plan views of variants of the time-of-flight camera in accordance with FIG. 8a, the lighting unit 20 can have a plurality of light sources or lighting units 20a-c. Mirror optics 38a-c are then associated with these lighting units 20a-c in different embodiments together, groupwise or even individually.

1. A 3D camera (10) having at least one image sensor (16, 16a-b) having an optical axis (46) for detecting three-dimensional image data from a monitored zone (12, 34, 36) and having a mirror optics (38) disposed in front of the image sensor (16, 16a) for expanding the field of view (44), wherein the mirror optics (38) has a front mirror surface (40) and a rear mirror surface (42) and is arranged in the field of view (44) of the image sensor (16, 16a-b) such that the front mirror surface (40) generates a first partial field of view (34) over a first angular region and the rear mirror surface (42) generates a second partial field of view (36) over a second angular region, with the first angular region and the second angular region not overlapping and being separated from one another by non-monitored angular regions.

2. The 3D camera (10) in accordance with claim 1, wherein the mirror optics (38) is shaped like a ridge roof whose ridge is aligned perpendicular to the optical axis (46) of the image sensor (16, 16a-b) and faces the image sensor (16, 16a-b) such that the roof surfaces form the front mirror surface (40) and the rear mirror surface (42).

3. The 3D camera (10) in accordance with claim 2, wherein the ridge roof is regular and symmetrical.

4. The 3D camera (10) in accordance with claim 2, wherein the ridge is arranged offset from the optical axis (46) of the image sensor (16, 16a).

5. The 3D camera (10) in accordance with claim 1, wherein the front mirror surface (40) and the rear mirror surface (42) have different sizes.

6. The 3D camera (10) in accordance with claim 1, wherein the front mirror surface (40) has a different inclination with respect to the optical axis (46) of the image sensor (16, 16a-b) than the rear mirror surface (42).

7. The 3D camera (10) in accordance with claim 1, wherein at least one of the mirror surfaces (40, 42) has a convex or concave contour at least sectionally.

8. The 3D camera (10) in accordance with claim 7, wherein the contour is formed in a direction of the optical axis (46) of the image sensor (16, 16a-b).

9. The 3D camera (10) in accordance with claim 7, wherein the contour is peripheral about the optical axis (46) of the image sensor (16, 16a-b) to vary the first angular region and/or the second angular region.

10. The 3D camera (10) in accordance with claim 1, which is configured as a stereo camera and for this purpose has at least two camera modules (14a-b), each having an image sensor (16a-b) in mutually offset perspectives, and has a stereoscopic unit (28) in which mutually associated partial regions are recognized by means of a stereo algorithm in images taken by the two camera modules (14a-b) and their distance is calculated with reference to the disparity, wherein each camera module (14a-b) is configured as a bidirectional camera with the aid of a mirror optics (38a-b) disposed in front of the image sensor (16, 16a-b) and having a front mirror surface (40) and a rear mirror surface (42).

11. The 3D camera (10) in accordance with claim 10, wherein the mirror optics (38a-b) have a convex contour which runs about the optical axis (46) of the associated image sensor (16a-b) and which is curved just so strongly that the non-monitored angular regions of a respective camera module (14a-b) correspond to a shaded zone (48a-b) by the other camera modules (14b-a).

12. The 3D camera (10) in accordance with claim 10, further comprising a lighting unit (20) for generating a structured lighting pattern in the monitored zone (12), wherein a mirror optics (38c) having a front mirror surface (40) and a rear mirror surface (42) is disposed in front of the lighting unit (20).

13. The 3D-camera in accordance with claim 1, which is configured as a time-of-flight camera and for this purpose has a lighting unit and a time-of-light unit (32) to determine the time-of-flight of a light signal which is transmitted from the lighting unit (20), which is remitted at objects in the monitored zone (12) and which is detected in the image sensor (16).

14. The 3D-camera in accordance with claim 10, wherein the mirror optics (38a-c) are configured as a common component.

15. A method of detecting three-dimensional image data from a monitored zone (12) by means of an image sensor (16, 16a-b) and by means of a mirror optics (38) disposed in front of the image sensor (16, 16a-b) for expanding the field of view (44),
the method comprising the step of:
dividing the field of view (44) at a front mirror surface (40) and a rear mirror surface (42) of the mirror optics (38) such that a first partial field of view (34) is generated over a first angular region and a second partial field of view (36) is generated over a second angular region, with the first angular region and the second angular region not overlapping and being separated from one another by non-monitored angular regions.
